(19) United States
(12) Patent Application Publication
(10) Pub. No.: US 2004/0136696 A1
(43) Pub. Date: Jul. 15, 2004

(54) Video/audio recording apparatus

(76) Inventors: Junji Shiokawa, Chigasaki-shi (JP); Hitoaki Owashi, Yokohama-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/745,572

(22) Filed: Dec. 29, 2003

Related U.S. Application Data
(63) Continuation of application No. 09/429,299, filed on Oct. 28, 1999.

(30) Foreign Application Priority Data
Oct. 30, 1998 (JP) 10-309848

(51) Int. Cl. H04N 5/76; H04N 5/781

(52) U.S. Cl. 386/98; 386/125

(57) ABSTRACT

A video/audio recording apparatus can record PS on a recordable optical disk and has a transport stream TS separating portion for separating video, audio packetized elementary streams (PES) of a certain program from TS, a separating portion for converting the video and audio PES into continuous elementary streams (ES), and a multiplexing portion for again packetizing the video and audio elementary streams and multiplexing the packetized video and audio streams according to a predetermined rule. The TS supplied from the outside is converted into PS by each Demux, the separating and coupling portions and the multiplexing portion, and recorded on the recording medium.

### BACKGROUND OF THE INVENTION

The present invention relates to video/audio recording apparatus for the digital recording of transmitted digital TV broadcast programs.

The transmission of digital television broadcasts has been developed, and digital VTRs have so far been proposed to record the programs received by a home receiver as digital data. As known examples, there are a video tape recorder described in the IEEE, TRANSACTION ON CONSUMER ELECTRONICS, AUGUST 1998 VOLUME 44, NUMBER 3, PP. 459-462, and a digital signal processor disclosed in JP-A-9-205616.

This VTR receives the digital data transmitted from a broadcasting station by a digital data receivable tuner, and records the received data directly on tape.

The operation of this VTR will be briefly described with reference to FIG. 2.

A broadcast signal transmitted from a broadcast station is received by an antenna 21. The received signal is supplied to a demodulator 22 where it is converted into a transport stream (TS) formed of compressed data of MPEG 2 standard.

The demodulated TS is fed to a signal processor 23, which then processes it on time base so that it can be recorded on a magnetic tape. The processed TS is directly recorded in the TS format on the magnetic tape 24. The above system makes use of its merit that, since the recording medium is a magnetic tape on which only the sequential access is fundamentally possible, the recording apparatus can be simplified by using the magnetic tape on which the TS can be directly recorded as a stream that is suitable to be simply reproduced in a sequential order from time point of view and that can be applied to broadcasting stations and so on.

In recent years, magnetic disks, optical disks and semiconductor memories have been developed as large-capacity storage media that can be used to record video information. In addition, an optical disk player that can reproduce an optical disk on which the compressed data of MPEG 2 was recorded has been produced on a commercial basis as a reproducer for the above MPEG 2 video signal. The stream of the MPEG 2 (Moving Picture Expert Group 2) recorded on this optical disk is a program stream (PS) that is of a packet structure different from the above-mentioned TS, and that has video and audio signals multiplexed.

The transport stream (PS), the program stream (PS), and the packetized elementary stream (PES) and elementary stream (ES) which will be mentioned later are well known in “Latest MPEG Textbook” (published by ASCII Inc., Aug. 1, 1994), and thus will not be described in detail.

### SUMMARY OF THE INVENTION

The above-mentioned optical disk player does not have any recording function but has only the reproducing function. However, recently recordable/reproducible optical disks have been brought to market together with the progress of related techniques. In addition, a recordable player that can also record the optical disk of this type will be placed soon on the market without doubt.

After this, if both the recordable player of this recordable/reproducible type and the player having only the reproducible function are put on the market and maintained together to be on the market, it is of course essential to provide compatibility therebetween so that the video and audio information recorded by the recordable player can be reproduced by the playback-only player.

FIG. 4 is a schematic block diagram of the above playback-only player.

A recorded medium 41 for use with the playback-only player that has been used so far has signals recorded in the format of program stream (PS). This player, in order to reproduce this type of data, includes PS separating means 42 for separating the PS in which the video and audio compressed streams are multiplexed, video and audio expanding means 43, 45 for respectively expanding the separated video elementary stream (ES-V) and audio elementary stream (ES-A), and video and audio digital/analog (DA) converting means 44, 46 for respectively converting the expanded video and audio digital data into analog video and audio signals. In this case, the marketed-now optical disk player having only the playback function has the function for reproducing the PS recorded on an optical disk, but does not have any function to reproduce the TS. Therefore, when an optical disk is recorded with TS by a recordable player that will be marketed in near future, it is necessary that a playback-only player which will be also placed on the market in near future add TS-reproducible functions such as TS separating means and PES separating means, thus making the apparatus complicated. The function to reproduce PS cannot be removed because the optical disk video sources now placed on the market are of PS recorded type.

Thus, considering the compatible system for both recordable player and playback-only player, it is desired that the video and audio information to be recorded on recording media such as optical disks be of the PS type.

The format of the currently transmitted digital television broadcast signals is MPEG 2 transport stream (TS). If this type of signals is converted into the program stream (PS) before it is recorded on, for example, the above-mentioned recordable player, it will be possible to obtain the highly compatible system mentioned previously.

In order to solve the above problems, the recordable player for repeatedly recordable optical disks has TS separating means for separating the TS into video and audio packetized elementary streams (PES) of a certain program, converting means for converting the video and audio PES into continuous elementary streams (ES), and multiplexing means for again packetizing each of the video and audio elementary streams, and multiplexing them according to a predetermined rule.

The TS supplied from the outside is converted into PS by each Demux, separating and coupling means and multiplexing means, and recorded on a medium.

### BRIEF DESCRIPTION OF THE DRAWINGS

FIG. 1 is a block diagram of a first embodiment of a video/audio recording apparatus according to the present invention.

FIG. 2 is a block diagram of a recording system for reference.

FIG. 3 is a block diagram of a second embodiment of a video/audio recording apparatus according to the present invention.

FIG. 4 is a block diagram of an optical disk player for reference.

FIG. 5 is a block diagram of a third embodiment of a video/audio recording apparatus according to the present invention.

### DESCRIPTION OF THE EMBODIMENTS

Embodiments of the present invention will hereinafter be described.

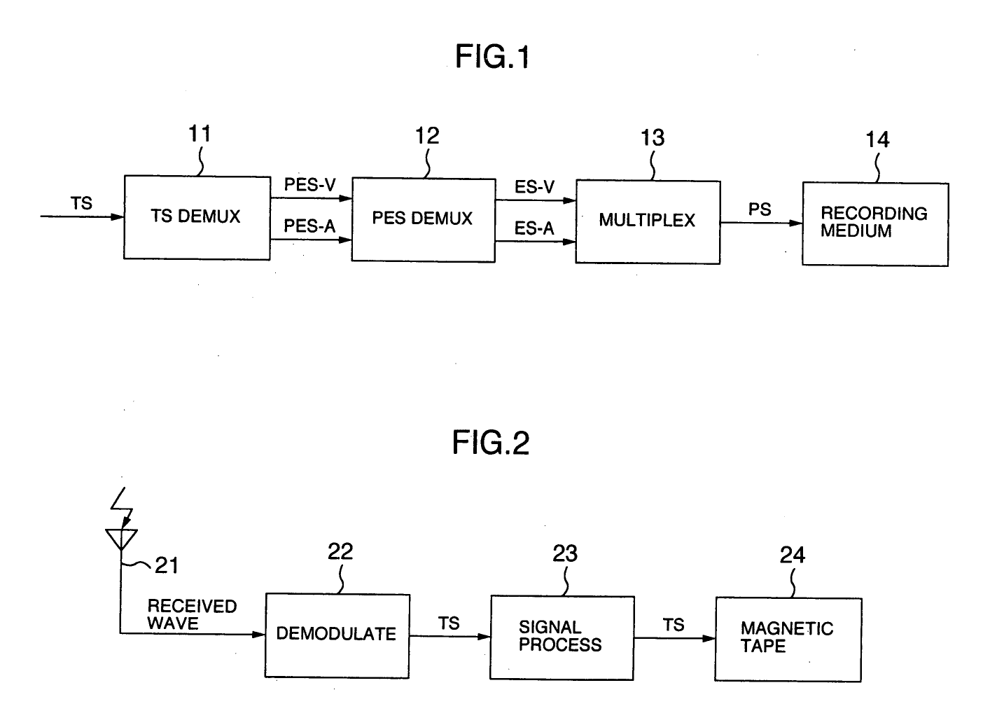

Referring to FIG. 1, there is shown a transport stream TS produced from a tuner that is able to receive transmitted digital television broadcasts or from the recorded medium of a video tape recorder that can digitally record the received broadcast. Reference character PES-V represents a packetized program stream of a compressed video signal of a desired program separated from the transport stream. PES-A designates a packetized program stream of a compressed audio signal of the desired program separated from the transport stream. ES-V indicates an elementary stream of a depaketized compressed video signal. ES-A denotes an elementary stream of a depacketized compressed audio signal. PS is a program stream resulting from packetizing again and multiplexing the above ES-V and ES-A.

The incoming TS from the outside is separated by a TS separating means 11 into the video and audio streams PES-V and PES-A of the desired program. The streams PES-V and PES-A are supplied to PES separating means 12, by which the packet headers and other parameter information are separated so that the input streams are converted into compressed streams ES-V and ES-A, respectively. The streams ES-V, ES-A are multiplexed into PS by multiplexing means 13, and recorded in the PS format on a recording medium 14.

Therefore, the playback-only player for the medium recorded by this apparatus can be constructed as shown in FIG. 4. This player is advantageous from the standpoint of compatible system since the TS separating means and PES separating means are not necessary to provide. In addition, both video and audio information are not deteriorated because there is no process in which the expanded video and audio data are again compressed.

The second embodiment of the invention will be described below.

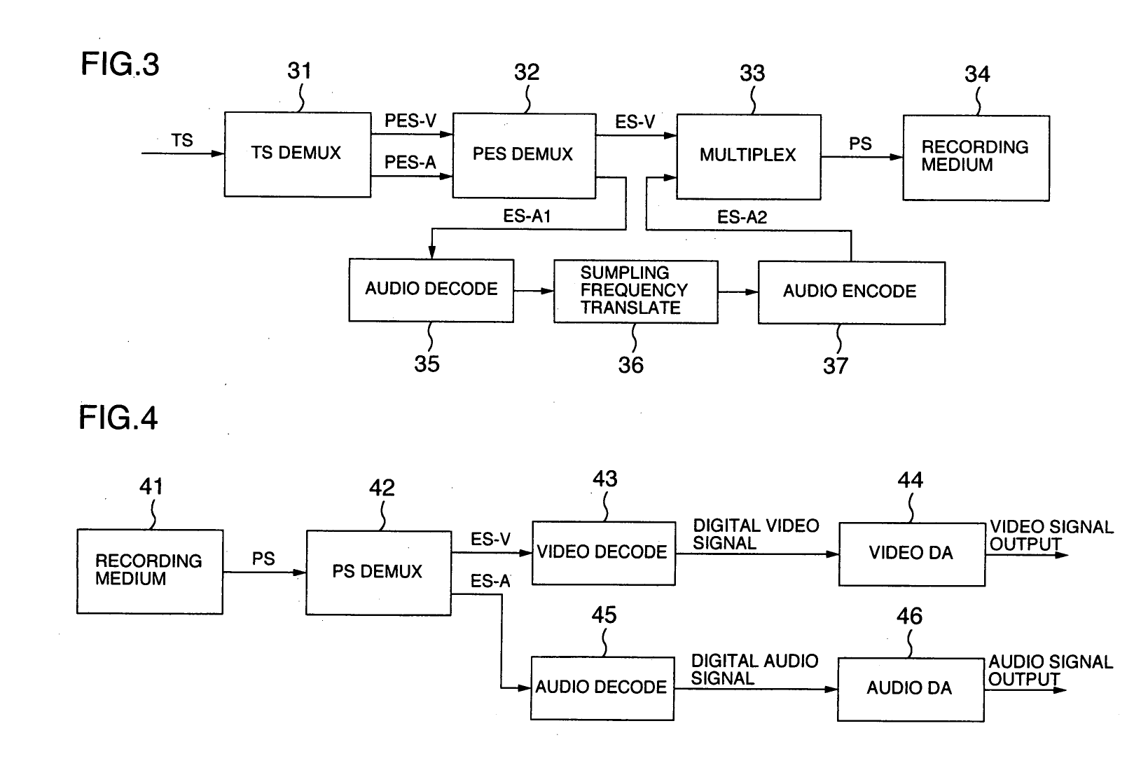

FIG. 3 is a block diagram of the second embodiment of a video/audio recording apparatus according to the invention.

Referring to FIG. 3, there are shown TS separating means 31, PES separating means 32, multiplexing means 33 and a recording medium 34 which are the same as those elements 11, 12, 13, 14 shown in FIG. 1, respectively.

There are also shown audio expanding means 35 for expanding the audio elementary stream (ES-A) that was compressed in a predetermined format, sampling frequency converting means 36 for converting the sampling frequency by arithmetic processing, which frequency is used when the audio signal is sampled, (for example, audio data sampled at a sampling frequency of 32 kHz is converted into audio data sampled at a sampling frequency of 48 kHz), and audio compressing means 37 for again compressing the digitized audio data in a certain format.

The incoming stream TS from the outside is supplied to the TS separating means 31 where it is separated into the video and audio streams PES-V and PES-A of a desired program. The streams PES-V, PES-A are fed to the PES separating means 32 by which the packet headers and other parameter information are separated so that they are converted into the compressed streams ES-V, ES-A1.

Here, the audio elementary stream ES-A1 is fed to the audio expanding means 35, and converted thereby into digital audio data of a predetermined sampling frequency (for example, 32 kHz). The sampling frequency of this data is converted (for example, into 48 kHz) by the sampling frequency converting means 36. This data is then compressed into an elementary stream (ES-A2) by the audio compressing means 37 for again compressing this data in a certain format. The stream ES-A2 is fed to the multiplexing means 33 by which it is multiplexed with the video stream ES-V. The multiplexed stream PS is recorded in the PS format on the recording medium 34.

Therefore, even though the sampling frequency of the incoming audio data from the outside is, for example, 32 kHz or 44.1 kHz, the apparatus of this embodiment records the stream PS including the audio compressed data that has been sampled at a sampling frequency of 48 kHz. Thus, the player can be simplified because the reproducing function needs, for example, only the capability of reproducing the PS data and the audio data of which the sampling frequency is 48 kHz.

Although the sampling frequency is converted from 32 kHz to 48 kHz or from 44.1 kHz to 48 kHz as mentioned above, it may be made arbitrarily without limiting to those frequencies.

The third embodiment of the invention will hereinafter be described.

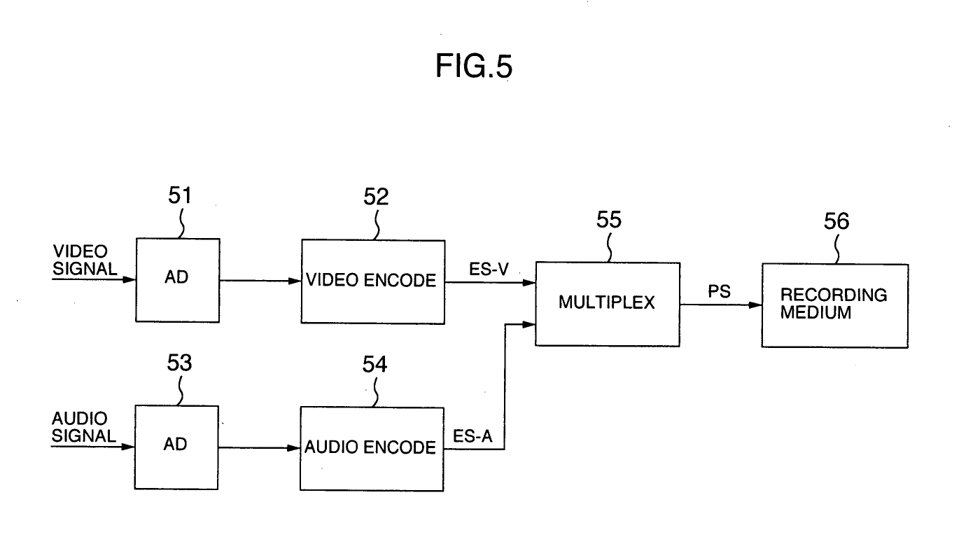

Referring to FIG. 5, in this embodiment, the incoming video and audio signals are normal analog signals and they can be supplied to and treated by this apparatus because the digital television broadcast receivable tuner or the like is sure to have the output function for these analog signals. The supplied video signal and audio signal are converted into digital signals by analog-digital converters 51, 53, respectively. The digitized video and audio signals are compressed into video and audio elementary streams (ES-V), (ES-A) on the basis of a certain compression format by video compressing means 52 and audio compressing means 54, respectively. The streams ES-V, ES-A are multiplexed into the program stream (PS) by multiplexing means 55, and then recorded on a recording medium 56.

In this case, the video, audio compressed data the tuner received in the TS form are once expanded to produce analog outputs, which are then again compressed so that they can be encoded into PS. Therefore, although this apparatus is disadvantageous in that particularly it is easy to deteriorate the picture quality, the most standard analog signals can be connected to the recording apparatus, and thus this apparatus is advantageous in that it can record the signals from all the video and audio apparatus.

Thus, the present invention can provide a video/audio recording apparatus that records in the PS form the TS output from the tuner capable of receiving transmitted digital television broadcasts, and the reproduced TS output from the video tape recorder capable of recording the TS output from the tuner. In addition, since the TS separating means and PES separating means are not necessary to reproduce the recorded medium that was recorded by this video/audio recording apparatus, even the playback apparatus for only PS can be used to reproduce that medium. Accordingly, the present invention can provide an inexpensive, highly compatible playback system.

What is claimed is:

1. A video/audio recording apparatus comprising:
PES separating (Demux) means for separating a transport stream (TS) supplied from the outside into video and audio packetized elementary streams (PES) of a certain program;
ES generating means for generating video and audio elementary streams (ES) by separating packet headers from said video and/or audio PES;
multiplexing means for packetizing said ES into predetermined data blocks, and multiplexing said packetized video and audio streams into a certain program stream (PS); and
recording means capable of recording on a recording medium.

2. A video/audio recording apparatus comprising:
PES separating (Demux) means for separating video and audio packetized elementary streams (PES) of a certain program from a transport stream (TS) supplied from the outside;
ES generating means for generating video and audio elementary streams (ES) by separating packet headers from said video and/or audio PES;
audio expanding means for expanding said audio ES;
sampling frequency converting means for converting the sampling frequency of said expanded audio signal;
audio compressing means for compressing said sampling-frequency-converted audio data on the basis of a predetermined compression format to produce an audio ES;
multiplexing means for packetizing said ES into predetermined data blocks and multiplexing said packetized video and audio streams into a certain program stream (PS); and
recording means capable of recording said PS on a recording medium.

3. A video/audio recording apparatus comprising:
first analog/digital converting means for converting an analog video signal into a digital signal;
second analog/digital converting means for converting an analog audio signal into a digital signal;
video compressing means for compressing said digital video signal on the basis of a predetermined format to produce a video elementary stream (ES-V);
audio compressing means for compressing said digital audio signal on the basis of a certain format to produce an audio elementary stream (ES-A);
multiplexing means for multiplexing said ES-V and ES-A according to a predetermined format; and
recording means capable of recording on a recording medium.
